(19) United States
(12) Patent Application Publication
(10) Pub. No.: US 2008/0139165 A1
(43) Pub. Date: Jun. 12, 2008

(54) DISASTER RESPONSE SYSTEM FOR CONVEYING A SITUATION STATUS AND LOCATION OF SUBSCRIBERS AND FOR INITIATING PRECONFIGURED RESPONSE PLANS

(75) Inventors: NONA E. GAGE, SEA RANCH LAKES, FL (US); MARK A. BARROS, WELLINGTON, FL (US); CHARLES P. SCHULTZ, NORTH MIAMI BEACH, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/609,216

(22) Filed: Dec. 11, 2006

(51) Int. Cl. H04M 11/04; H04Q 7/00

(52) U.S. Cl. 455/404.1; 455/404.2; 340/539.11; 455/414.1; 340/539.1

(57) ABSTRACT

The present solution includes a method for reporting a status indicator using a mobile device during a disaster. In the method, a status indicator can be entered into a mobile communication device. The status indicator can he communicated to a disaster response system. The disaster response system can also automatically determine a location of the mobile communication device. The disaster response system can make the status indicator and the location available to concerned parties. The location and status indicators can be continuously updated for a duration of a disaster allowing the concerned parties to receive current information about subscribers. In one embodiment, a set of previously established actions associated with user developed disaster response plan can be initiated by the disaster response system.

### BACKGROUND

1. Field of the Invention

The present invention relates to emergency communications and, more particularly, to emergency notification systems for mobile telephone users within a disaster region to quickly and efficiently convey situational status indicators to concerned parties.

2. Description of the Related Art

Widespread disaster occurrences, such as hurricanes, floods, and terrorist attacks result in communication networks being disabled and/or saturated. A significant portion of the call volumes are associated with friends and loved ones communicating with others located within or proximate to a disaster region to determine whether those they care for are safe or are in need of assistance. The typical communications, which overload communication networks, are person to person voice communications, which consume a relative large amount of bandwidth of a telecommunications infrastructure.

A few emergency contact centers and/or systems have been established in an attempt to assure loved ones in a manner less burdensome to a communication infrastructure. TextOK.com has established a server that allows users to register their mobile phone numbers and a set of contacts. When a text message of “OK” is sent to an established number, each contact in the established set is sent a message indicating that the registered user is alright. Other services permit a user to send an “OK” message to a centralized server, which others can contact to see whether the OK message has been sent that indicates the user is not in danger.

All of these existing systems require that a user communicates with a messaging site, which may not be possible if communication networks are down or saturated or if a person is suffering as a result of a disaster. Further, concerned parties are provided with no information other than a message or a lack of message for an unknown reason. Even if a concerned party desires to assist a disaster sufferer, they are not aware of where aid is to be rendered or what type of aid is needed. Moreover, a concerned party is not able to enlist assistance from rescue personnel, since a need is too uncertain. That is, the potential disaster sufferer may have forgotten to send an OK message during the chaotic period during or after a disaster. Another very realistic possibility is that a user in an affected area is unable to communicate out of a disaster region due to network saturation, mobile telephony device problems, or due to a mobile communication network being down.

Another problem that occurs in the aftermath of a disaster relates to deployment of rescue personnel and properly targeting relief resources to areas having the greatest need. Recent disasters, such as Hurricane Katrina and the Sep. 11, 2001 terrorists attacks, illustrate that government agencies and public service organizations lack a means to assess areas and people in need of assistance immediately following a disaster. Aggravated hardships, increased injury, and loss of life can result from disaster sufferers not receiving timely aid. What is needed is a system that permits aid to be quickly targeted to those having the greatest need. What is also needed is a means for communicating situational status to concerned parties in a manner that conserves limited communication resources present after a disaster and that provides sufficient information to be helpful to those who wish to aid disaster sufferers.

### SUMMARY OF THE INVENTION

The present invention discloses a solution for providing a situational status and a location of a subscriber potentially affected by a disaster to concerned parties. The situational status and location can be obtained by querying a centralized disaster response system, which is presumed to be outside a disaster region, thereby providing information to concerned parties without burdening a communication infrastructure of an affected area. In one arrangement the disaster response system can automatically initiate a set of preconfigured, subscriber configurable actions. Different actions can be initiated depending upon disaster type, subscriber location, a status indicator of a subscriber, and other parameters.

More specifically, when a disaster is detected, mobile devices of subscribers can be queried for location and wireless connectivity by a centrally located disaster response system. When a subscriber is away from a disaster area, this information can be recorded and it can be presumed that the subscriber is alright. When a subscriber is proximate to a disaster area, the subscriber's device can be queried for a status indicator and for an optional user provided message. This status indicator and message can be provided at any time by the subscriber, who is not forced to fight for a communication connection with the disaster response system during a time where dedicated mobile communication channels can be difficult to obtain. Instead, a user can enter their status indicator and optional message, which is thereafter automatically conveyed to the disaster response system using either a polling or a pushing methodology.

In one embodiment, a special communication channel can be reserved for the disaster response system to obtain the situational status indicators and messages, which can consume relatively little bandwidth compared to voice communications. Further, when communications are intermittent, the disaster response system can automatically and repetitively query mobile devices for desired status information. When the disaster response system contacts a mobile device and no status information has been recorded, the system can record a location of the device and can prompt a user to enter status information. When a mobile device is unable to be contacted, the disaster response server can look-up a last known location of user and to ascertain whether mobile communications are down in that area. Further, a last known activity for the mobile device can be ascertained and compared against disaster related times. This can be an indicator of whether the mobile device was left uncharged, turned off, or unconnected due to some disaster independent reason. All of this information can be recorded and reported to concerned parties.

In one contemplated scenario, the disaster response system can determine areas and/or subscribers in greatest need of relief based upon subscriber status indicators and subscriber locations. For example, if eighty percent of subscribers in a first region report a situational status indicator that the subscribers are in dire need of aid and if ninety percent of subscribers in a second region report that they are alright, then relief workers can be directed towards the first region. Further, location information of subscribers and messages relating to relief needs can be used to further focus disaster relief efforts. In one embodiment, media capabilities of mobile phones can be utilized for disaster assessment purposes. For instance, one or more subscribers can use a camera, a video capture feature, an audio capture feature, and the like of their mobile device to convey disaster details to the disaster response system.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can he implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a disaster response system for informing concerned parties of a situation status of subscribers, who may have been effected by a disaster.

FIG. 2 is a schematic diagram of a subscriber status reporting system configured for use during disasters.

FIG. 3 is a flow chart of a method of one possible process that can be used by a disaster response system in accordance with one embodiment of the inventive arrangements disclosed herein.

FIG. 4 is a chart showing a set of disaster response plans established for a subscriber and initiated by a disaster response system in accordance with an embodiment the inventive arrangements disclosed herein.

### DETAILED DESCRIPTION OF THE INVENTION

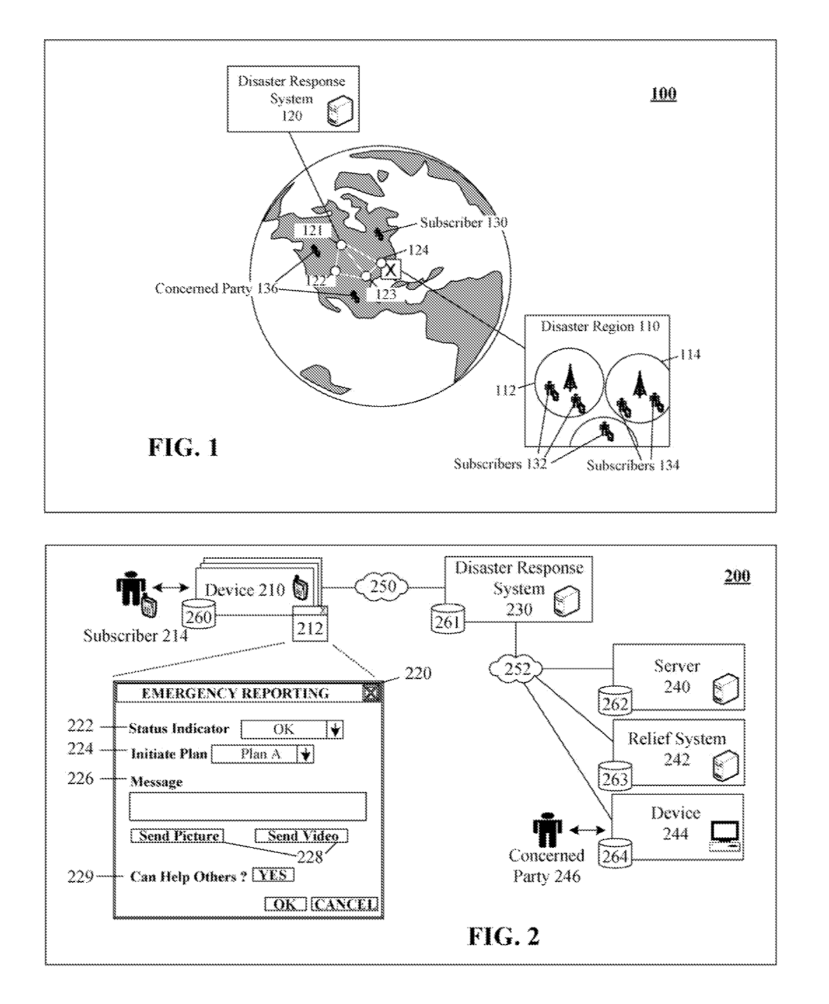

FIG. 1 is a schematic diagram of a disaster response system 100 for informing concerned parties 136 of a situation status of subscribers 130-134, who may have been effected by a disaster. In system 100, a disaster, such as a hurricane, flood, fire, tsunami, and the like can affect a disaster region 110. The disaster region 110 can include multiple mobile communication zones 112-114 within which included subscribers 132-134 can communicate a status indicator, which indicates whether the subscriber 132-134 is alright or is in need of help due to the disaster. A location of each subscriber 130-134 can also be automatically obtained, through either a Global Position System (GPS) component or through triangulation based upon a relative position of a mobile device within a wireless mobile communication network. When a subscriber, such as subscriber 130, is outside disaster region 110, system 120 can assume that the subscriber 130 is alright and is not in need of disaster related assistance.

Concerned parties 136 can communicate with the disaster response system 120 to obtain the status indicator and location of queried subscribers 132-134. For example, a mother (e.g., concerned party 136) can contact the emergency response system 120 to determine whether her daughter (e.g., one of subscribers 130-134) is alright in the aftermath of a disaster,

In one embodiment, data obtained from the subscribers 130-134 can be aggregated and used for disaster relief purposes. For example, subscribers 130-132 can predominately submit status indicators to server 120 indicating that they are alright while subscribers 134 can predominantly submit status indicators indicating that they are in need of assistance. The aggregated data can be reported to disaster relief workers and/or agencies to let these workers/agencies know that timely attention is needed for zone 114 associated with subscribers 134 but that other zones in region 110 appear to be in less need. In general, the aggregated data can help the relief workers and/or agencies determine a response order and/or to proportion relief resources based upon need. Specific locations of subscribers 130-134 in need of assistance can also be provided from system 120 to disaster relief workers/agencies along with any other relevant information.

It should be appreciated that during a disaster, a communication infrastructure of a disaster region 110 can be crippled and/or saturated making communications into and out of region 110 difficult. The disaster response system 120 is designed to alleviate a portion of the burden place upon the communication infrastructure of region 110 by handling communications using resources outside the affected region 110.

For example, status indicators and locations of subscribers 132-134 can be exchanged between system 120 and concerned parties 136 using unaffected telecommunication resources. To ensure that the disaster response system 120 is external to region 110, a series or cluster of linked communication resources can be geographically dispersed, shown by system elements 121-124. Any elements, such as 124, which are included in disaster region 110, can be disabled for a particular disaster. Therefore, for the disaster region 110 shown in system 100, the disaster response system 120 would actively utilize only system elements 121-123.

Various additional measures can be taken to ensure that subscribers 132-134 in region 110 are able to communicate with system 120. In one embodiment, a communication channel of a mobile telephony system can be reserved specifically for communications between subscribers 130-134 and system 120, which helps resolve network saturation issues. Reserving a communication channel for status information can have a relatively insignificant effect on an overall communication infrastructure as data exchanges consume relatively few resources.

In one embodiment, multiple communication/information transmission options can be established to enable subscribers 130-134 to communicate with system 120. For example, mobile telephony and push-to-talk (PTT) channels of mobile devices can both be used for sending status indicators to system 120. It is also contemplated that ad hoc networks can be dynamically established (i.e., through BLUETOOTH functionality of mobile telephones) to enable subscribers 130-134 to convey status and location information when wide area network (WAN) communications are unavailable. Local wireless data networks, such as WIMAX networks and WIFI networks can also be used for relaying status information to system 120, when other communication channels are unavailable. Moreover, it is contemplated that relief workers can deploy communication access points, such as WIFI access points, for the purpose of receiving situation status information from areas that are otherwise disconnected from system 120.

FIG. 2 is a schematic diagram of a subscriber status reporting system 200 configured for use during disasters. In system 200, a device 210 associated with a subscriber 214 can be linked to disaster response system 230 via network 250. System 230 can be linked to server 240, relief system 242, and device 244 via network 252. Device 244 can be a device associated with concerned party 246. The various computing devices in system 200 can be associated with data stores 260-264 as shown.

Software 212 on device 210 can permit subscriber 214 to report situation status information to system 230. Interface 220 shows one contemplated reporting interface. Using interface 220, a user can select a status indicator 222, such as OK, NEED HELP, and IN CRITICAL NEED. In one configuration, an option indicating whether subscriber 214 can help others 229 can be included.

Additionally, in one embodiment, a previously designed plan can be selectively initialized 224. The plan can be one that was previously established with system 230. For example, if subscriber 214 is a parent unable to pick-up a child due to the disaster, a previously designated party 246 can be tasked with the child's well being, whenever Plan A is selected. A message 226 entry option can also exist that permits the subscriber 214 to send a message detailing a situation to the system 230.

In another embodiment, options to utilize specialized sensors and/or components of the device 210 can be present in interface 220. For example, options 228 can exist to utilize a built-in camera or video feature of the device 210 to send a picture or video of the post-disaster situation to system 230.

Communications between device 210 and system 230 can utilize a push and/or pull methodology. For example, device 210 can push data to system 230 over network 250, or data can be pulled from device 210 by system 230. When a network 250 connection is intermittent, repeated communication attempts, possibly using different communication channels, can be automatically performed until system 230 receives information from device 210.

In one arrangement, system 230 can combine data obtained from one or more devices 210 with information obtained from other sources, such as server 240, in order to create a more comprehensive situation assessment. For example, server 240 can provide satellite images of a disaster region, which can be combined with a subscriber location so that a concerned party 246 is able to see not only a status indicator and a location for a subscriber 214, but a picture of that area as well. Disaster response system 230 can convey data to one or more disaster relief systems 242, which can provide assistance to needful subscribers 214.

Device 210 can be any computing device capable of communicating status and location information to system 230. Device 210 can include a mobile telephone, a computer, a personal data assistant (PDA's), a two-way radio, a GPS device, a media player, an entertainment system, a wearable computing device, and the like. Different communication modes can be available to the device 210, which can permit information to be shared over a personal area network (PAN) and/or a Wide Area Network (WAN).

Networks 250 and 252 can include any hardware/software/and firmware necessary to convey digital content encoded within carrier waves. Digital content can be contained within analog or digital signals and conveyed though data or voice channels. Networks 250-252 can include network equipment, such as routers, data lines, hubs, and intermediary servers which together form a data or telephony network. Networks 250-252 can include mobile communication components, such as cellular communication towers, two-way radio transceiving components, and the like.

Data stores 260-264 can each be a physical or virtual storage space configured to store digital information. Each of data stores 260-264 can be physically implemented within any type of hardware including, but not limited to, a magnetic disk, an optical disk, a semiconductor memory, a digitally encoded plastic memory, a holographic memory, or any other recording medium. The data stores 260-264 can be a stand-alone storage unit as well as a storage unit formed from a plurality of physical devices. Additionally, information can be stored within each data store 260-264 in a variety of manners. For example, information can be stored within a database structure or can be stored within one or more files of a file storage system, where each file may or may not be indexed for information searching purposes. Further, data stores 260-264 can utilize one or more encryption mechanisms to protect stored information from unauthorized access.

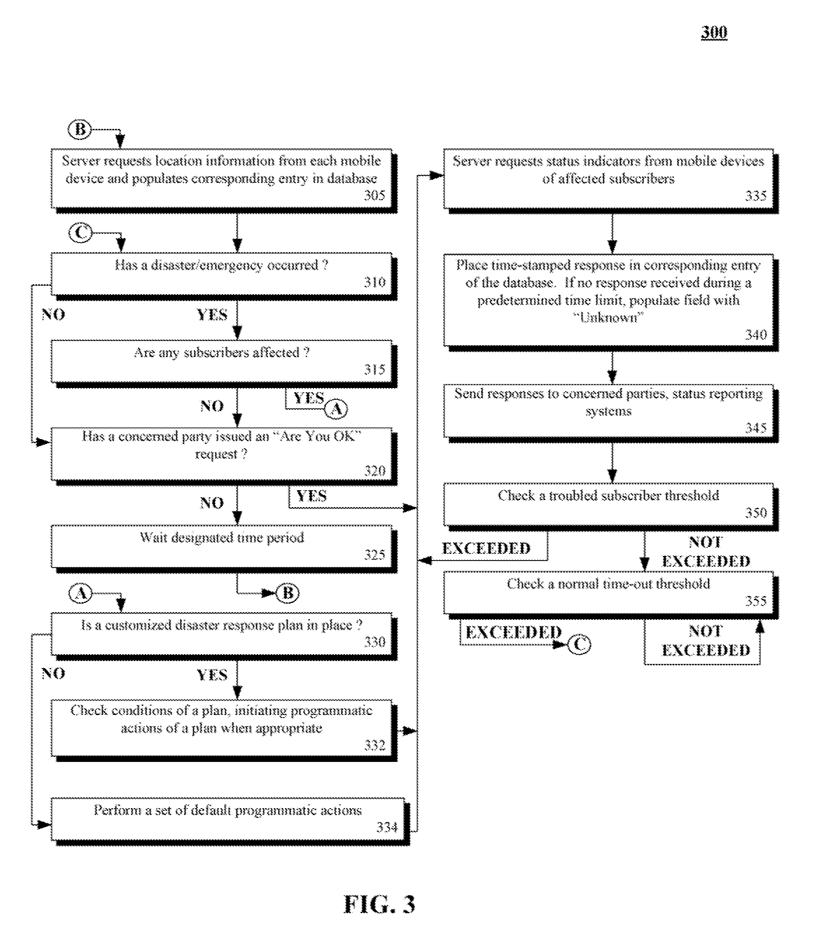

FIG. 3 is a flow chart of a method 300 of one possible process that can be used by a disaster response system in accordance with one embodiment of the inventive arrangements disclosed herein. Method 300 is provided for illustrative purposes and the invention is not to be construed as limited in this regard.

The method can begin in step 305, where a server can request location information from mobile devices. Corresponding database entries can be populated using this information. In step 310, a determination can be made as to whether a disaster has occurred. If so, the method can proceed from step 310 to step 315, where a determination can be made as to whether any subscribers have been affected by the disaster. This determination can be based on the location information of step 305. One factor that, can be considered in step 315 is a quantity of subscribers who have manually activated an emergency response plan. That is, a subscriber having an unknown affected status that is proximately located to a set of other subscribers, who have each manually activated an emergency response plan, can be presumed to be affected by an emergency. Further, sufficient subscriber emergency plan activation in a given area can cause step 310 to be automatically evaluated as true for that area. If results of step 310 or step 315 are negative, then method can proceed to step 320, where a check can he performed to determine if anyone issued an “Are You OK” request. If not, the method can wait for a specified period, as shown in step 325, after which the method can repeat step 305.

If in step 315 one or more subscribers are affected by a disaster, the method can proceed to step 330, where a disaster response system can determine whether conditions have been satisfied for a user defined plan. If so, programmatic actions associated with that plan can be initiated, as shown by step 332. Otherwise, a set of default actions for the subscriber can be taken, as noted in step 334. For example, a master contact can be contacted and informed of the status indicator and the location information of the mobile device. Other contacts associated with the subscriber can also be contacted. In another example, a Web site containing subscriber status information can be updated with the subscriber's status indicator and location. Concerned parties, such as family members, can be granted access to the Web site, through which they can look-up the last known location and situational status of the subscriber.

An affirmative response for step 320 can lead to step 335, as can completed steps 332 and 334. In step 335, a server of a disaster response system can request conditions for each affected or queried subscriber. In step 340, a time-stamp response to each of these queries can be placed in a corresponding database entry. If no response is received within a predetermined time period, the response field can be populated with an “Unknown” indication. In step 345, when all responses are determined, responses can be sent to each concerned party and/or to status reporting systems, such as the aforementioned Web site.

In step 350, a troubled subscriber timeout threshold can be checked. This threshold can be associated with potentially threatened subscribers, which includes users having an “Unknown” status and subscribers who set a status indicator to indicate that they were not alright. When the threshold is exceeded, the method can loop to step 335, where the server can request condition information for the potentially threatened subscribers. In step 355, a normal timeout threshold can be checked. When this threshold is exceeded, the method can loop back to step 310, where the method can check to see if the disaster has ended, if not, status information for ail subscribers can be updated.

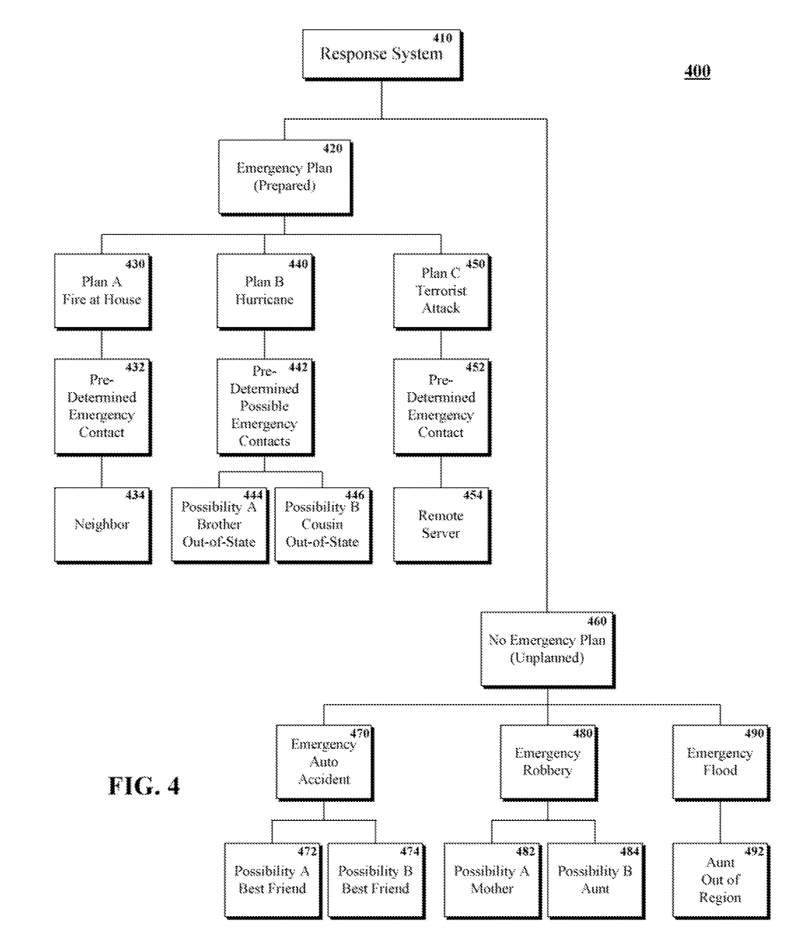

FIG. 4 is a chart 400 showing a set of disaster response plans established for a subscriber and initiated by a disaster response system in accordance with an embodiment the inventive arrangements disclosed herein. The chart 400 can, for example, represent the plans associated with plan element 224 of system 200. Each plan is associated with a set of conditions, such as a disaster type, a subscriber location, a subscriber status, and the like. When these conditions occur, a set of predefined programmatic actions are automatically initiated. Different sub-elements of an overall plan can be selectively triggered or adjusted depending upon whether related conditions have occurred.

For example, a rescue plan during a fire can specify that a closest relative to the fire is to assist children near the tire. Each of the plan specified relatives can be associated with a mobile telephony device having location determination capabilities. A disaster response system can determine which of the family members is closest to the fire by querying each device. The nearest device can then be contacted, its user apprised of the situation, and informed of their assigned duties regarding the children.

The top level of chart 400 is a basic response system 410. The response system 410 can be manually triggered by an authorized user or automatically triggered based upon a disaster being detected. Prepared response plans are shown in block 420. These plans 420 can include Plan A for a fire at a house 430, Plan B for a hurricane 440, and Plan C for a terrorist attack 450,

When a fire at a house is detected 430, a pre-determined emergency contact can be contacted 432. If this contact is unavailable, a set of backup contacts can be iteratively contacted. One of the contacts can include a neighbor 434 proximate to the house.

When a hurricane is detected 440, a potentially different set of predetermined possible emergency contacts 442 can be notified. These contacts can include an out of state brother 444 and an out of state cousin 446,

When a terrorist attack is detected 450, a predetermined contact set can be contacted 452. Further a remote server 454, such as an FBI server or a police server, can be provided all known information.

Unplanned emergencies 460 can include an emergency auto accident 470, a robbery 480, and a flood 490. During an auto accident 470 one or more friends 472-474 can be contacted. For a robbery 480, a mother 482 and/or an aunt 484 can be notified of the situation. The mother 482 and/or aunt 484 can, for instance, be watching a business traveler's residence when he is away on a long trip. When a flood 490 occurs, an aunt 492 outside of a threat region can be contacted.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for reporting a status indicator using a mobile communication device during a disaster comprising:
entering a situation status indicator in a mobile communication device;
communicating the status indicator to a disaster response system;
the disaster response system automatically determining a location of the mobile communication device; and
the disaster response system making the status indicator and the location available to a plurality of concerned parties.

2. The method of claim 1, further comprising;
iteratively repeating the communicating, determining, and making steps for a duration of a disaster, wherein the disaster response system provides a continuously updated status indication and location of a subscriber associated with the mobile communication device to the plurality of concerned parties.

3. The method of claim 1, further comprising;
the disaster response system polling a plurality of mobile communication devices, which include the mobile communication device, to acquire status indicators and mobile communication device locations; and
associating an identifier for the mobile communication device and corresponding location and status indicators within a database structure.

4. The method of claim 3, further comprising:
iteratively repeating the communicating, determining, and making steps for a duration of a disaster for each of the plurality of mobile communication devices, wherein the disaster response system provides a continuously updated status indication and location of each subscriber associated with one of the mobile communication devices to the plurality of concerned parties.

5. The method of claim 3, further comprising:
aggregating data from the plurality of mobile communication devices to determine areas and people affected by a disaster, which are in need of assistance; and
providing the aggregated data to at least one of an entity and agency in charge of providing disaster relief.

6. The method of claim 1, further comprising:
a subscriber associated with the mobile communication device establishing a plurality of conditional disaster plans with the disaster response system;
each of the disaster response plans including a set of user-configured programmatic actions to be automatically taken responsive to an occurrence of associated conditions;
responsive to a disaster, the disaster response system determining whether the associated conditions have occurred based at least in part upon the determined location and the status indicator; and
when a set of conditions has occurred, automatically initiating the associated set of programmatic actions.

7. The method of claim 6, further comprising:
entering a plan triggering command in the mobile communication device;
communicating the plan triggering command to the disaster response system; and
automatically initiating the set of programmatic actions associated with the plan triggering command.

8. The method of claim 1, wherein the status indicator is one of a set of system defined situation status indicators, said set including at least one indicator signifying that a mobile communication device user is alright and including at least one indictor signifying that the mobile communication device user is in need of assistance, said method further comprising;
entering a textual message into the mobile communication device;
communicating the textual message to the disaster response system; and
the disaster response system making the textual message available to the plurality of concerned parties.

9. The method of claim 1, further comprising*.
using an input capture mechanism of the mobile communication device, capturing input to create a media document, said media document comprising at least one of audio, video, and an Image;
communicating the media document to the disaster response system; and
the disaster response system making the media document available to the plurality of concerned parties.

10. The method of claim 1, further comprising:
one of the concerned parties contacting the disaster response system to query the disaster response system about a subscriber associated with the mobile communication device;
the disaster response system initiating the communicating and the determining steps in response to the contacting step; and
the disaster response system providing the concerned party the status indicator and the location in response to the query.

11. The method of claim 1, further comprising:
the communicating step failing to establish communications with the mobile communication device that results in the automatically determining step failing;
the disaster response system automatically determining a last known location for the mobile communication device and an associated time;
the disaster response system making the last known location and the time available to the plurality of concerned parties.

12. The method of claim 1, the making step further comprising:
automatically conveying an electronic document to each of the concerned parties associated with a subscriber of the mobile communication device, said electronic message including the status indicator and the location.

13. The method of claim 1, the making step further comprising:
updating an automated system with the status indicator and the location for the mobile communication device, which is associated with a subscriber;
permitting each of the plurality of concerned parties to contact the automated system and to identify the subscriber; and
automatically providing the status indicator and the location to each of the concerned parties after the subscriber has been identified.

14. The method of claim 1, wherein said steps of claim 1 are steps performed by at least one machine in accordance with at least one computer program stored within a machine readable memory, said computer program having a plurality of code sections that are executable by the at least one machine.

15. A method for conveying situation status indicators of subscribers to concerned parties during a disaster comprising:
detecting an occurrence of a disaster affecting a region;
determining a set of mobile telephony devices associated with the region, each mobile telephony device being associated with a subscriber;
determining a location for each of the mobile telephony devices:
attempting to obtain a situation status indicator from each of the mobile telephone devices;
storing results of the attempting step and the determined locations in a data store that relates the results and the locations to a corresponding one of the mobile telephony devices; and
providing stored information to concerned parties, wherein each concerned party receives the stored results and the determined location for at least one corresponding subscriber.

16. The method of claim 15 wherein the providing step further comprises performing one action from a set of actions consisting of an action of automatically sending electronic messages to a set of previously designated contact points associated with each of the subscribers wherein the electronic messages include the stored results and the determined locations, and an action of establishing an automated system that the concerned parties are able to access wherein the automated system is able to process queries pertaining to particular ones of the subscribers and to provide query results comprising the determined location and the stored results that correspond to queried subscribers.

17. The method of claim 15 further comprising:
identifying a set of disaster responses associated with the subscribers, which were previously configured by the subscribers, each disaster response being a data driven response that varies depending upon ascertainable conditions, said ascertainable conditions comprising a disaster type, a value of a situation status indicator, and a location of an associated mobile telephony device;
for each subscriber, automatically determining the ascertainable conditions; and
for each subscriber, automatically initiating at least one disaster response appropriate for the determined conditions.

18. The method of claim 15 wherein the method provides real-time status information about the subscribers to the concerned parties utilizing telecommunication infrastructure resources positioned outside of the region, and wherein when a mobile telephony device of a subscriber Is unable to be contacted, the stored results indicate this inability as well as an indication of whether mobile telephony service is available in a location in which the mobile telephony device is believed to be.

19. The method of claim 16 further comprising;
aggregating information for geographic portions of the region, said aggregated information being based upon values of situation status indicators received from mobile communication devices that are located within the geographic portion as ascertained from the determined locations; and
automatically providing the aggregated information to disaster relief personnel to help focus disaster relief efforts.

20. A disaster response system for reporting situational status indicators of subscribers to concerned parties comprising:
a plurality of mobile communication devices having an interface through which a user is able to enter a situation status indicator;
a disaster response system configured to dynamically and repetitively obtain the situation status indicators from the mobile communication devices and to dynamically and repetitively determine a location of the mobile communication devices during a disaster, wherein said disaster response system performs at least one programmatic action for subscribers associated with the mobile communication devices based upon the location of the mobile communication device and the status indicator received from the mobile communication device; and
a plurality of computing devices that are each associated with concerned parties, wherein the disaster response system provides a current status indicator and a location of the mobile communication device to the plurality of computing devices for computing devices previously associated with the mobile communication device and for computing devices responsive to a query of a subscriber associated with the mobile communication device.
